(19) United States
(12) Patent Application Publication
(10) Pub. No.: US 2026/0184958 A1
(43) Pub. Date: Jul. 2, 2026

(54) POLYIMIDE VARNISH FOR COATING CONDUCTOR WITH IMPROVED HEAT DISSIPATION FOR COATING CONDUCTOR AND POLYIMIDE COATING MATERIAL COMPRISING THE SAME

(71) Applicant: PI Advanced Materials Co., Ltd., Chungcheongbuk-do (KR)

(72) Inventors: Gyeong Min Moon, Chungcheongbuk-do (KR); Gyeong Hyeon Ro, Chungcheongbuk-do (KR); Ik Sang Lee, Chungcheongbuk-do (KR)

(73) Assignee: PI Advanced Materials Co., Ltd., Chungcheongbuk-do (KR)

(21) Appl. No.: 19/131,107

(22) PCT Filed: Nov. 23, 2023
(86) PCT No.: PCT/KR2023/019008

§ 371 Date: May 19, 2025

(30) Foreign Application Priority Data
Nov. 30, 2022 (KR) 10-2022-0164651

(51) Int. Cl. C09D 179/08; C08G 73/10; C08K 3/38; C09D 7/40; C09D 7/61

(52) U.S. Cl. CPC C09D 179/08; C08G 73/105; C08G 73/1071; C08K 3/38; C09D 7/61; C09D 7/69; C08G 2150/00; C08K 2003/382; C08K 2201/001; C08K 2201/005

(57) ABSTRACT

Provided is polyimide varnish comprising: a polyamic acid solution containing diamine monomer and dianhydride monomer as polymerized units; an additive containing boron nitride; and a dispersant.

### TECHNICAL FIELD

The present invention relates to polyimide varnish and polyimide coating materials comprising the same. Specifically, the present invention relates to polyimide varnish for coating a conductor with improved heat dissipation characteristics and polyimide coating materials comprising the same.

### BACKGROUND ART

An insulating layer (insulation coating) that covers a conductor is required to have excellent insulation properties, adhesion to the conductor, heat resistance, mechanical strength, etc. Further, in electrical equipment with high applied voltage, such as motors used at high voltages, high voltage is applied to insulated wires that form the electrical equipment, and there is a high possibility of partial discharge (corona discharge) occurring on a surface of the insulated coating. The occurrence of corona discharge may cause a local temperature increase or generation of ozone or ions, which may result in deterioration of the insulation coating of the insulated wires, causing premature insulation breakdown and shortening the lifespan of the electrical equipment. For the above-described reasons, insulated wires used at high voltage are required to have an improvement in the corona discharge initiation voltage, and in order to achieve the improvement, it is known that lowering the dielectric constant of the insulating layer is effective.

Examples of resins usable in the insulating layer may include polyimide resin, polyamideimide resin, and polyesterimide resin, etc. In particular, polyimide resin among these resins is a material with excellent heat resistance and insulation properties and has excellent properties for use as a coating material for conductors.

Polyimide resin refers to a highly heat-resistant resin obtained by performing solution polymerization on aromatic dianhydride and aromatic diamine or aromatic diisocyanate to produce a polyamic acid derivative, followed by ring-closure dehydration at high temperature and imidization. A method of forming an insulation coating using the polyimide resin may include, for example, a method of applying or coating polyimide varnish, a precursor of polyimide resin, around a conductor wire, and then imidizing the polyimide varnish in a curing furnace capable of heat treatment at a predetermined temperature.

The method of forming the insulation coating may cause differences in physical properties, productivity, and manufacturing cost of the produced insulation coating depending on conditions such as a temperature of the curing furnace, the number of coatings of polyimide varnish, and the coating speed, etc. In other words, forming an insulation coating at a high temperature may be advantageous for producing an insulation coating having excellent physical properties, and productivity may increase as the number of coatings is small or the coating speed is fast.

However, when a temperature of the curing furnace is extremely high, problems may arise such as defects occurring on a surface of the produced insulation coating or carbonization of the polyimide resin. When the number of coatings is extremely small or the coating speed is extremely fast, physical properties of polyimide coating materials to be produced may be deteriorated. In addition, despite excellent physical properties thereof, general polyimide resin does not have excellent adhesion to conductors, and thus problems of appearance defects may occur when forming an insulation coating.

As described above, there are many difficulties in improving properties required for polyimide varnish and polyimide resin produced therefrom. In particular, since it is common for improving one property to result in a decrease in other properties, satisfying multiple properties simultaneously is a task that is constantly being researched in related technical fields.

Therefore, there is a high need for polyimide varnish for coating a conductor that has excellent productivity and process efficiency, and simultaneously satisfies the heat resistance, insulation, and mechanical properties of polyimide while having excellent adhesion to the conductors as described above.

### DISCLOSURE OF INVENTION

### Technical Problem

An object of the present invention is to provide polyimide varnish comprising an additive and a dispersant to be capable of maintaining excellent heat dissipation characteristics despite changes over time and improving the dispersibility of the additive.

Another object of the present invention is to provide polyimide varnish for coating a conductor for use in windings for an electric vehicle (EV) and polyimide coating materials comprising the same.

Still another object of the present invention is to provide polyimide in which the polyimide varnish is imidized.

### Solution to Problem

Various modifications can be made and various embodiments may be implemented in the present invention, and specific exemplary embodiments are illustrated in the drawings and described in detail. However, these exemplary embodiments are not intended to limit the present invention, and should be understood to comprise all modifications, equivalents, and substitutes included in the spirit and scope of the present invention.

Terms used in the present application are only used to describe specific embodiments and are not intended to limit the present invention. Singular expressions include plural expressions unless the context clearly indicates otherwise. In the present specification, terms such as “comprise” or “have” are intended to designate the presence of features, numbers, steps, operations, components, parts, or combinations thereof described in the specification and it should not be understood as precluding the possibility of the presence or addition of one or more other features, numbers, steps, operations, components, parts, or combinations thereof.

When amounts, concentrations, or other values or parameters herein are given as ranges, preferred ranges, or lists of upper desirable values and lower desirable values, it should be understood as specifically disclosing all ranges formed by any pair of any upper range limit or preferred value and any lower range limit or preferred value, regardless of whether the scope is separately disclosed.

Where ranges of numerical values are stated herein, unless otherwise stated, it is intended that the endpoints of the range and the scope of the parent invention within the range are not limited to the specific values stated when defining the range.

As used herein, “dianhydride” is intended to include precursors or derivatives thereof, which are also referred to as “dianhydride” or “acid dianhydride”. These products may technically not be dianhydrides, but will nonetheless react with diamines to form polyamic acids, and the polyamic acids may be converted back into polyimides.

As used herein, “diamine” is intended to include precursors or derivatives thereof, which may technically not be diamines, but will nonetheless react with dianhydride acid to form a polyamic acid, and the polyamic acid may be converted back into polyimide.

Further, unless defined otherwise, all terms used herein, including technical or scientific terms, have the same meaning as commonly understood by one of ordinary skill in the art to which the present invention belongs. Terms such as those defined in commonly used dictionaries should be interpreted as having a meaning consistent with the meaning in the context of the related art, and unless explicitly defined in the present application, it is not to be construed in an idealized or overly formal sense. Specific details for the implementation of the invention will be described below.

In one general aspect, the present invention relates to polyimide varnish comprising an additive and a dispersant to be capable of maintaining excellent heat dissipation characteristics despite changes over time and improving the dispersibility of the additive, and a polyimide coating material comprising the same.

### Polyimide Varnish

The present invention provides polyimide varnish comprising a polyamic acid solution containing diamine monomer and dianhydride monomer as polymerized units; an additive containing boron nitride; and a dispersant.

### Polyamic Acid Solution

The diamine monomer may comprise at least one selected from the group consisting of 1,4-diaminobenzene (PPD), 4,4′-diaminodiphenyl ether (ODA),
2,2-bisaminophenoxyphenylpropane (BAPP), metaphenylenediamine,
3,3′-dimethylbenzidine, 2,2′-dimethylbenzidine, 2,4-diaminotoluene,
2,6-diaminotoluene, 3,5-diaminobenzoic acid (DABA), 3,4′-diaminodiphenyl ether,
4,4′-diaminodiphenylmethane (4,4′-methylenedianiline),
3,3′-dimethyl-4,4′-diaminobiphenyl, 2,2′-dimethyl-4,4′-diaminobiphenyl (m-tolidine),
2,2′-bis(trifluoromethyl)-4,4′-diaminobiphenyl,
3,3′-dimethyl-4,4′-diaminodiphenylmethane,
3,3′-dicarboxy-4,4′-diaminodiphenylmethane,
3,3′,5,5′-tetramethyl-4,4′-diaminodiphenylmethane, bis(4-aminophenyl) sulfide,
4,4′-diaminobenzanilide, 3,3′-dimethoxybenzidine, 2,2′-dimethoxybenzidine,
3,3′-diaminodiphenyl ether, 3,3′-diaminodiphenyl sulfide, 3,4′-diaminodiphenyl
sulfide, 4,4′-diaminodiphenyl sulfide, 3,3′-diaminodiphenyl sulfone,
3,4′-diaminodiphenyl sulfone, 4,4′-diaminodiphenylsulfone,
3,3′-diaminobenzophenone, 4,4′-diaminobenzophenone,
3,3′-diamino-4,4′-dichlorobenzophenone, 3,3′-diamino-4,4′-dimethoxybenzophenone,
3,3′-diaminodiphenylmethane, 3,4′-diaminodiphenylmethane,
2,2-bis(3-aminophenyl) propane, 2,2-bis(4-aminophenyl) propane,
2,2-bis(3-aminophenyl)-1,1,1,3,3,3-hexafluoropropane,
2,2-bis(4-aminophenyl)-1,1,1,3,3,3-hexafluoropropane, 3,3′-diaminodiphenyl sulfoxide, 3,4′-diaminodiphenyl sulfoxide, 4,4′-diaminodiphenyl sulfoxide,
1,3-bis(3-aminophenyl)benzene, 1,3-bis(4-aminophenyl)benzene,
1,4-bis(3-aminophenyl)benzene, 1,4-bis(4-aminophenyl)benzene,
1,3-bis(4-aminophenoxy)benzene (TPE-R), 1,4-bis(3-aminophenoxy)benzene (TPE-Q), 1,3-bis(3-aminophenoxy)-4-trifluoromethylbenzene,
3,3′-diamino-4-(4-phenylphenoxy)benzophenone,
3,3′-diamino-4,4′-di(4-phenylphenoxy)benzophenone, 1,3-bis(3-aminophenyl sulfide)benzene, 1,3-bis(4-aminophenyl sulfide)benzene, 1,4-bis(4-aminophenyl sulfide)benzene, 1,3-bis(3-aminophenylsulfone)benzene,
1,3-bis(4-aminophenylsulfone)benzene, 1,4-bis(4-aminophenylsulfone)benzene,
1,3-bis[2-(4-aminophenyl) isopropyl]benzene,
1,4-bis[2-(3-aminophenyl) isopropyl]benzene,
1,4-bis[2-(4-aminophenyl) isopropyl]benzene, 3,3′-bis(3-aminophenoxy) biphenyl,
3,3′-bis(4-aminophenoxy) biphenyl, 4,4′-bis(3-aminophenoxy) biphenyl,
4,4′-bis(4-aminophenoxy) biphenyl, bis[3-(3-aminophenoxy)phenyl]ether,
bis[3-(4-aminophenoxy)phenyl]ether, bis[4-(3-aminophenoxy)phenyl]ether,
bis[4-(4-aminophenoxy)phenyl]ether, bis[3-(3-aminophenoxy)phenyl]ketone,
bis[3-(4-aminophenoxy)phenyl]ketone, bis[4-(3-aminophenoxy)phenyl]ketone,
bis[4-(4-aminophenoxy)phenyl]ketone, bis[3-(3-aminophenoxy)phenyl]sulfide,
bis[3-(4-aminophenoxy)phenyl]sulfide, bis[4-(3-aminophenoxy)phenyl]sulfide,
bis[4-(4-aminophenoxy)phenyl]sulfide, bis[3-(3-aminophenoxy)phenyl]sulfone,
bis[3-(4-aminophenoxy)phenyl]sulfone, bis[4-(3-aminophenoxy)phenyl]sulfone,
bis[4-(4-aminophenoxy)phenyl]sulfone, bis[3-(3-aminophenoxy)phenyl]methane,
bis[3-(4-aminophenoxy)phenyl]methane, bis[4-(3-aminophenoxy)phenyl]methane,
bis[4-(4-aminophenoxy)phenyl]methane, 2,2-bis[3-(3-aminophenoxy)phenyl]propane,
2,2-bis[3-(4-aminophenoxy)phenyl]propane,
2,2-bis[4-(3-aminophenoxy)phenyl]propane,
2,2-bis[3-(3-aminophenoxy)phenyl]-1,1,1,3,3,3-hexafluoropropane,
2,2-bis[3-(4-aminophenoxy)phenyl]-1,1,1,3,3,3-hexafluoropropane,
2,2-bis[4-(3-aminophenoxy)phenyl]-1,1,1,3,3,3-hexafluoropropane, and
2,2-bis[4-(4-aminophenoxy)phenyl]-1,1,1,3,3,3-hexafluoropropane, and may be preferably 4,4′-diaminodiphenyl ether (ODA).

The dianhydride monomer may comprise at least one selected from the group consisting of pyromellitic dianhydride (PMDA), biphenyl tetracarboxylic dianhydride (BPDA), benzophenone tetracarboxylic dianhydride (BTDA), oxidiphthalic dianhydride (ODPA), diphenylsulfone-3,4,3′,4′-tetracarboxylic dianhydride (DSDA), bis(3,4-dicarboxyphenyl) sulfide dianhydride,
2,2-bis(3,4-dicarboxyphenyl)-1,1,1,3,3,3-hexafluoropropane dianhydride,
2,3,3′,4′-benzophenone tetracarboxylic dianhydride,bis(3,4-dicarboxyphenyl) methane dianhydride, 2,2-bis(3,4-dicarboxyphenyl) propane dianhydride, pphenylenebis(trimelytic monoester acid anhydride), p-biphenylenebis(trimelytic monoester acid anhydride), m-terphenyl-3,4,3′,4′-tetracarboxylic dianhydride, pterphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride,
1,4-bis(3,4-dicarboxyphenoxy) biphenyl dianhydride,
2,2-bis[(3,4-dicarboxyphenoxy)phenyl]propane dianhydride (BPADA),
2,3,6,7-naphthalene tetracarboxylic acid dianhydride,
1,4,5,8-naphthalenetetracarboxylic dianhydride, and
4,4′-(2,2-hexafluoroisopropylidene)diphthalic acid dianhydride, and may be preferably pyromellitic dianhydride (PMDA).

In the present invention, in the total dianhydride monomers, pyromellitic dianhydride (PMDA) may be included in a ratio of 50 mol % or more, specifically 60 mol % or more, 70 mol % or more, 75 mol % or more, 80 mol % or more, 85 mol % or more, 90 mol % or more, 95 mol % or more, 99 mol % or more, or 100 mol % or more.

Further, in the total diamine monomers, 4,4′-diaminodiphenyl ether (ODA) may be included in a ratio of 50 mol % or more, specifically 60 mol % or more, 70 mol % or more, 75 mol % or more, 80 mol % or more, 85 mol % or more, 90 mol % or more, 95 mol % or more, 99 mol % or more, or 100 mol % or more.

The polyamic acid solution may contain the diamine monomer in an amount of 90 to 110 mol %, preferably 95 to 105 mol %, more preferably 98 to 102 mol %, and even more preferably 99 to 101 mol %.

The polyamic acid solution may contain the dianhydride monomer in an amount of 90 to 110 mol %, preferably 95 to 105 mol %, more preferably 98 to 102 mol %, and even more preferably 100 mol %.

The polyamic acid solution may contain 95 to 105 mol % of the dianhydride monomer based on 100 mol % of diamine monomer, for example, the lower limit of the dianhydride monomer may be 95.5 mol % or more, 96 mol % or more, 96.5 mol % or more, 97 mol % or more, 97.5 mol % or more, 98 mol % or more, 98.5 mol % or more, 99 mol % or more, or 99.5 mol % or more, and the upper limit thereof may be 105 mol % or less, 104 mol % or less, 103 mol % or less, 102 mol % or less, 101 mol % or less, or 100 mol % or less.

The polyamic acid solution may contain the dianhydride monomer and the diamine monomer in a molar ratio of 6:4 to 4:6.

The polyamic acid solution may further contain an organic solvent.

The organic solvent may include at least one selected from the group consisting of Nmethyl-pyrrolidone (NMP), N,N′-dimethylformamide (DMF), N,N′-diethylformamide (DEF), N,N′-dimethylacetamide (DMAc), dimethylpropanamide (DMPA), naphtha, diethylpropionamide (DEPA), N-ethylpyrrolidone (NEP), xylene, gamma-butyrolactone, gamma-valerolactone, and N,N-diethylacetamide (DEAc), and preferably, may be a mixed solvent containing N,N′-dimethylacetamide (DMAc) and naphtha.

The mixed solvent may be a mixture of N,N′-dimethylacetamide (DMAc) and naphtha at a mass ratio (w/w) of 70:30 to 100:0, preferably 80:20 to 90:10, and more preferably 85:15.

### Additive

The polyimide varnish of the present invention may contain an additive to improve heat dissipation characteristics, and may particularly contain boron nitride. The boron nitride has high thermal conductivity characteristics and is preferable as an additive for producing materials having high electrical insulation, high temperature stability, and excellent corrosion resistance to acids.

The additive may have an amount of 0.1 to 20% by weight relative to the weight of the polyamic acid solution. For example, the lower limit of the amount of the additive may be 0.5% by weight or more, 1.0% by weight or more, 1.5% by weight or more, 2.0% by weight or more, 2.5% by weight or more, 3.0% by weight or more, 3.5% by weight or more, 4.0% by weight or more, 4.5% by weight or more, or 5.0% by weight or more, and the upper limit thereof may be 18% by weight or less, 16% by weight or less, 15% by weight or less, 10% by weight or less, 9.5% by weight or less, 9.0% by weight or less, 8.5% by weight or less, 8.0% by weight or less, 7.5% by weight or less, 7.0% by weight or less, 6.5% by weight or less, 6.0% by weight or less, 5.5% by weight or less, or 5.0% by weight or less.

When the amount of the additive exceeds 20% by weight, it is not desirable since mechanical properties of the produced polyimide coating material may decrease, and the amount of the additive is excessively large, making it difficult to achieve even dispersion. Meanwhile, when the amount of the additive is less than 0.1% by weight, it is not preferable since there is no effect of improving heat dissipation characteristics.

The additive may have a particle size (D90) of 1 to 10 μm. For example, the lower limit thereof may be 1.5 μm, 1.7 μm, 1.9 μm, 2.0 μm, 2.2 μm, 2.4 μm, 2.6 μm, 2.8 μm, 3.0 μm, 3.1 μm, 3.2 μm, 3.3 μm, 3.4 μm or 3.5 μm or more, and the upper limit thereof may be 9.5 μm, 9.0 μm, 8.5 μm, 8.0 μm, 7.5 μm, 7.0 μm, 6.5 μm, 6.0 μm, 5.5 μm, 5.0 μm, 4.5 μm, 4.0 μm, 3.8 μm, 3.7 μm or 3.6 μm or less.

The boron nitride may be at least one type selected from the group consisting of cubic boron nitride (cBN), amorphous boron nitride (aBN), and hexagonal boron nitride (hBN), and preferably hexagonal boron nitride (hBN).

### Dispersant

Meanwhile, boron nitride (BN) may have a problem of easy agglomeration into polyimide due to the difference in polarity from polyimide (PI), and the polyimide varnish of the present invention may contain a dispersant to improve the dispersibility of the additive.

The dispersant may include at least one selected from the group consisting of a polyvinyl-based dispersant, a polyethylene-based dispersant, a polyester-based dispersant, a polycarboxylic acid ester-based dispersant, an unsaturated polyamidebased dispersant, a polycarboxylic acid-based dispersant, a polycarboxylic acid alkyl salt dispersant, a polyacrylic-based dispersant, a polyethyleneimine-based dispersant, and a polyurethane-based dispersant, and preferably, the polyurethane-based dispersant may be used. The dispersion ability of boron nitride may be improved due to the strong polarity of the polyurethane-based dispersant.

The dispersant may have an acid value in the range of 10 to 200 mgKOH/g or an amine value in the range of 5 to 200 mgKOH/g, but is not limited thereto.

In an embodiment, the acid value of the dispersant may have a lower limit of about 20 mgKOH/g or more, 30 mgKOH/g or more, 40 mgKOH/g or more, 50 mgKOH/g or more, 60 mgKOH/g or more, 70 mgKOH/g or more, 80 mgKOH/g or more, or 90 mgKOH/g or more, and may have an upper limit of about 190 mgKOH/g or less, 180 mgKOH/g or less, 170 mgKOH/g or less, 160 mgKOH/g or less, 150 mgKOH/g or less, 140 mgKOH/g or less, 130 mgKOH/g or less, 120 mgKOH/g or less, 110 mgKOH/g or less, or 100 mgKOH/g or less. Here, the acid value refers to the number obtained by dividing the acid group (—COOH) of the dispersant by potassium hydroxide (KOH) amount needed for titration with KOH (a value expressed in milligrams (mg) of the titrated KOH amount needed per 1g of the dispersant).

In an embodiment, the amine value of the dispersant may have a lower limit of about 10 mgKOH/g or more, about 15 mgKOH/g or more, about 20 mgKOH/g or more, 30 mgKOH/g or more, 40 mgKOH/g or more, 50 mgKOH/g or more, 60 mgKOH/g or more, 70 mgKOH/g or more, 80 mgKOH/g or more, or 90 mgKOH/g or more, or may have an upper limit of about 190 mgKOH/g or less, 180 mgKOH/g or less, 170 mgKOH/g or less, 160 mgKOH/g or less, 150 mgKOH/g or less, 140 mgKOH/g or less, 130 mgKOH/g or less, 120 mgKOH/g or less, 110 mgKOH/g or less, or 100 mgKOH/g or less. Here, the amine value refers to the number obtained by dividing the amino group (—NH₂, —NHR or —NR₂) of the dispersant by potassium hydroxide (KOH) amount needed for titration with KOH (a value expressed in milligrams (mg) of the titrated KOH amount needed per 1g of the dispersant).

The dispersant may have a specific gravity of 0.5 to 1.5 g/ml at 20° C. For example, the lower limit of the specific gravity of the dispersant may be 0.6 g/ml, 0.7 g/ml, 0.8 g/ml, 0.9 g/ml or 1.00 g/ml or more. Further, the upper limit of the specific gravity of the dispersant may be 1.4 g/ml, 1.3 g/ml, 1.2 g/ml, 1.1 g/ml, 1.07 g/ml or 1.05 g/ml or less.

The dispersant may have an amount of 0.01 to 5.0% by weight relative to the weight of the polyamic acid solution. For example, the lower limit of the amount of the dispersant may be 0.05% by weight or more, 0.1% by weight or more, 0.2% by weight or more, 0.3% by weight or more, 0.4% by weight or more, 0.5% by weight or more, 0.6% by weight or more, 0.7% by weight or more, 0.8% by weight or more, 0.9% by weight or more, or 1.0% by weight or more, and the upper limit of the amount of the dispersant may be 4.0% by weight or less, 3.0% by weight or less, 2.0% by weight or less, 1.5% by weight or less, 1.4% by weight or less, 1.3% by weight or less, 1.2% by weight or less, 1.1% by weight or less, or 1.0% by weight or less.

When the amount of the dispersant exceeds 5.0% by weight, it is not preferable since thermal stability is lowered. Meanwhile, when the amount of the additive is less than 0.01% by weight, it is not preferable since there is no effect of improving the dispersibility of the additive.

### Polyimide Varnish and Cured Product Thereof

The polyimide varnish may have a solid content of 5 to 40% by weight, preferably 10 to 35% by weight, more preferably 15 to 30% by weight, and even more preferably 20 to 30% by weight. In an embodiment, the solid content of the polyimide varnish may be 25% by weight.

The present invention may comprise a cured product in the form of a film in which the polyimide varnish is imidized.

In an embodiment, the polyimide varnish according to the present invention may have a thickness of 10 to 50 μm after curing. For example, the lower limit of the thickness after curing may be 12 μm or more, 14 μm or more, 16 μm or more, 18 μm or more, 20 μm or more, 21 μm or more, 22 μm or more, 23 μm or more, or 24 μm or more, and the upper limit thereof may be 50 μm or less, 48 μm or less, 46 μm or less, 44 μm or less, 42 μm or less, 40 μm or less, 35 μm or less, 30 μm or less, 29 μm or less, 28 μm or less, or 27 μm or less.

In an embodiment, the polyimide varnish according to the present invention may have a thermal conductivity of 0.2 to 10.0 W/mK after curing. For example, the lower limit of the thermal conductivity after curing may be 0.3 W/mK or more, 0.35 W/mK or more, 0.4 W/mK or more, 0.42 W/mK or more, 0.45 W/mK or more, 0.47 W/mK or more, 0.49 W/mK or more, or 0.5 W/mK or more. Further, the upper limits of the thermal conductivity after curing may be 9.0 W/mK or less, 8.0 W/mK or less, 7.0 W/mK or less, 6.0 W/mK or less, 5.0 W/mK or less, 4.0 W/mK or less, 3.0 W/mK or less, 2.0 W/mK or less, 0.9 W/mK or less, 0.8 W/mK or less, 0.7 W/mK or less, 0.65 W/mK or less, 0.63 W/mK or less, 0.60 W/mK or less, 0.58 W/mK or less, 0.57 W/mK or less, 0.56 W/mK or less, 0.55 W/mK or less, or 0.54 W/mK or less. In an embodiment, to measure the thermal conductivity, thermal diffusivity in a thickness direction of the cured polyimide varnish was measured according to a laser flash method using thermal diffusivity measurement equipment (Model LFA 447, NETZSCH. GmbH, Selb, Germany), and thermal conductivity was calculated by multiplying the thermal diffusivity measured values by density (weight/volume) and specific heat (specific heat measured value using DSC).

In an embodiment, the polyimide varnish according to the present invention may have a glass transition temperature (Tg) after curing in the range of 200 to 450° C. For example, the lower limit of the glass transition temperature may be 250° C. or higher, 300° C. or higher, 350° C. or higher, 355° C. or higher, 360° C. or higher, 365° C. or higher, 367° C. or higher, or 370° C. or higher. The upper limit of the glass transition temperature may be 445° C. or lower, 440° C. or lower, 435° C. or lower, 430° C. or lower, 425° C. or lower, 420° C. or lower, 415° C. or lower, 410° C. or lower, or 405° C. or lower. In an embodiment, the glass transition temperature was determined by measuring the peak value of tangent delta (Tan δ) on the cured polyimide varnish using dynamic mechanical analysis (DMA) under conditions where the temperature was raised up to 450° C. at a rate of 10° C./min.

In an embodiment, a thermal decomposition temperature (Td) at 5% weight loss after curing the polyimide varnish according to the present invention may be 400 to 600° C. The lower limit of the thermal decomposition temperature may be, for example, 450° C. or higher, 470° C. or higher, 490° C. or higher, 500° C. or higher, 505° C. or higher, 510° C. or higher, 515° C. or higher, or 520° C. or higher. The upper limit of the thermal decomposition temperature may be, for example, 590° C. or lower, 580° C. or lower, 570° C. or lower, or 560° C. or lower. The thermal decomposition temperature may be measured using TA's thermogravimetric analyzer Q50. In a specific example, the cured product of the polyimide varnish (cured polyimide varnish) may be heated up to 150° C. at a rate of 10° C./min under a nitrogen atmosphere and then maintained isothermally for 30 minutes to remove moisture. Then, the temperature may be raised up to 600° C. at a rate of 10° C./min, and the temperature at which a 5% weight loss occurs may be measured.

In an embodiment, the polyimide varnish according to the present invention may have a dielectric breakdown voltage (BDV) of 50 to 350 kV/mm after curing. For example, the lower limit of the dielectric breakdown voltage may be 60 kV/mm or more, 65 kV/mm or more, 70 kV/mm or more, 75 kV/mm or more, 77 kV/mm or more, 80 kV/mm or more or 82 kV/mm or more, and the upper limit thereof may be 300 kV/mm or less, 250 kV/mm or less, 220 kV/mm or less, 200 kV/mm or less, 198 kV/mm or less, 195 kV/mm or less, 194 kV/mm or less, 193 kV/mm or less, 192 kV/mm or less, 191 kV/mm or less, 190 kV/mm or less, 189 kV/mm or less, or 188 kV/mm or less. In an embodiment, the dielectric breakdown voltage (BDV) of the cured product of the polyimide varnish was measured according to the ASTMD149 standard.

In another aspect of the present invention, there is provided a polyimide coating material comprising a cured product of the polyimide varnish.

In an embodiment, a method of producing the polyimide coating material may comprise coating polyimide varnish on a conductor surface; and imidizing the polyimide varnish coated on a surface of the conductor.

The conductor may be a copper wire made of copper or a copper alloy, but may also comprise conductors made of other metal materials such as silver wire, etc., or various metal-plated wires such as aluminum or tin-plated conducting wires, etc. The conductor and coating material may have a thickness according to the KS C3107 standard. A diameter of the conductor may be in the range of 0.3 to 3.2 mm, and a standard film thickness of the coating material (average value of the maximum film thickness and minimum film thickness) may be 21 to 194 μm for type 0, 14 to 169 μm for type 1, and 10 to 31 μm for type 2. Depending on the cross-sectional shape of the conductor, the conductor may be a round wire, a rectangular wire, a hexagonal wire, etc., but is not limited thereto.

In another aspect of the present invention, there is provided an electric wire comprising the polyimide coating material.

Specifically, the wire may be a covered wire comprising the polyimide coating material produced by coating the polyimide varnish on a surface of the wire, followed by imidization. In an embodiment, the covered wire may comprise an electric wire; and a coating material in which the above-described polyimide is coated on a surface of the wire and imidized.

Further, the present invention may provide an electronic device comprising the covered wire. The electronic device may be, for example, an electric motor.

### Advantageous Effects of Invention

The polyimide varnish of the present invention and the polyimide coating material comprising the same may contain an additive and a dispersant, thereby maintaining excellent heat dissipation characteristics despite changes over time and providing excellent dispersibility of the additive.

In addition, the improvement of the heat dissipation characteristics may also increase the lifespan of the motor, and may have excellent usability in coating a conductor for use in windings for electric vehicles (EVs).

### BRIEF DESCRIPTION OF DRAWINGS

FIG. 1 shows appearances of a boron nitride-containing additive depending on the type of dispersant to confirm the dispersibility of the additive.

### BEST MODE FOR CARRYING OUT THE INVENTION

The following Examples are presented to help understanding of the present invention. The following examples are only provided to more easily understand the present invention, but the content of the present invention is not limited by these Examples.

### Example

### Example 1. Polyimide Varnish

### Example 1-1

99.5 to 100 mol % of pyromellitic dianhydride (PMDA), which is a dianhydride compound, and 100 mol % of 4,4′-diaminodiphenyl ether (ODA), which is a diamine compound, were dispersed in a mixed solvent in which N,N′-dimethylacetamide (DMAc) and Naphtha were mixed at a ratio of 85:15 (w/w) to prepare a polyamic acid solution, wherein the polyimide solid content was aimed at 25% by weight.

To the polyamic acid solution, 5% by weight of a boron nitride (BN) additive having a particle size (D90) of 1 to 10 μm and 0.1% by weight of a polyurethane-based dispersant (amine value 48 mgKOH/g, specific gravity (20° C.) 1.05 g/ml) were added to produce polyimide varnish.

### Example 1-2

Polyimide varnish was prepared in the same manner as Example 1-1, except that 1% by weight of the polyurethane-based dispersant was added instead of 0.1% by weight of the polyurethane-based dispersant in Example 1-1.

### Example 1-3

Polyimide varnish was prepared in the same manner as Example 1-1, except that 1.5% by weight of the polyurethane-based dispersant was added instead of 0.1% by weight of the polyurethane-based dispersant in Example 1-1.

### Comparative Example 1-1

Polyimide varnish was prepared in the same manner as Example 1-1, except that 5% by weight of boron nitride (BN) additive and 0.1% by weight of polyurethane-based dispersant were not added instead of adding 5% by weight of boron nitride (BN) additive and 0.1% by weight of polyurethane-based dispersant in Example 1-1.

### Comparative Example 1-2

Polyimide varnish was prepared in the same manner as Example 1-1, except that only 5% by weight of boron nitride (BN) additive was added instead of adding 5% by weight of boron nitride (BN) additive and 0.1% by weight of polyurethane-based dispersant in Example 1-1.

Table 1 below shows the composition and content of polyimide varnishes according to Examples 1-1 to 1-3 and Comparative Examples 1-1 and 1-2. Here, in Table 1 below, the percent (%) by weight (wt %) of the additive indicates the total content of the additive relative to the total weight of the polyamic acid solution, and the wt % of the dispersant indicates the total content of the dispersant relative to the total weight of the polyamic acid solution.

TABLE 1

| | | Additive | Dispersant | |
|---|---|---|---|---|
| | | Boron | PU-based | |
| Classification | Solution | nitride | dispersant | |
| Example 1-1 | Polyamic acid | 5 wt % | 0.1 | wt % |
| Example 1-2 | solution | 5 wt % | 1 | wt % |
| Example 1-3 | (PAA Varnish) | 5 wt % | 1.5 | wt % |

| | | |
|---|---|---|
| Comparative Example 1-1 | — | — |
| Comparative Example 1-2 | 5 wt % | — |

### Example 2. Polyimide Cured Product

### Example 2-1

The polyimide varnish prepared according to Example 1-1 was rotated at a high speed of 2,000 rpm to remove air bubbles. Then, the degassed polyimide varnish was applied on a glass substrate (230 mm×230 mm, thickness: 0.55 mmt) using a spin coater.

Next, a cured polyimide product in the form of a film was obtained by curing under the conditions of 110° C. (20 minutes)→150° C. (20 minutes)→200° C. (20 minutes)→300° C. (20 minutes) under a nitrogen atmosphere.

### Example 2-2

A cured polyimide product was prepared in the same manner as Example 2-1 except that the polyimide varnish according to Example 1-2 was used instead of the polyimide varnish according to Example 1-1 in Example 2-1.

### Example 2-3

A cured polyimide product was prepared in the same manner as Example 2-1 except that the polyimide varnish according to Example 1-3 was used instead of the polyimide varnish according to Example 1-1 in Example 2-1.

### Comparative Example 2-1

A cured polyimide product was prepared in the same manner as Example 2-1 except that the polyimide varnish according to Comparative Example 1-1 was used instead of the polyimide varnish according to Example 1-1 in Example 2-1.

### Comparative Example 2-2

A cured polyimide product was prepared in the same manner as Example 2-1 except that the polyimide varnish according to Comparative Example 1-2 was used instead of the polyimide varnish according to Example 1-1 in Example 2-1.

### Example 3. Polyimide Coating Material

### Example 3-1

An electric wire (coated wire) containing a polyimide coating material with a coating thickness of 33 to 35 μm was prepared by applying, in a coating curing furnace, the polyimide varnish according to Example 1-1 to a copper wire with a conductor diameter of 1 mm, in which the coating thickness per round was adjusted to between 2 and 6 μm, the minimum and maximum temperatures of the coating curing furnace were adjusted to 350 to 550° C., and the coating speed of the copper wire was adjusted to 12 to 32 m/min, and repeating the coating, drying, and curing process a total of 7 times.

### Example 3-2

A cured polyimide product was prepared in the same manner as Example 3-1 except that the polyimide varnish according to Example 1-2 was used instead of the polyimide varnish according to Example 1-1 in Example 3-1.

### Example 3-3

A cured polyimide product was prepared in the same manner as Example 3-1 except that the polyimide varnish according to Example 1-3 was used instead of the polyimide varnish according to Example 1-1 in Example 3-1.

### Experimental Examples

### Experimental Example 1. Evaluation of Dispersibility

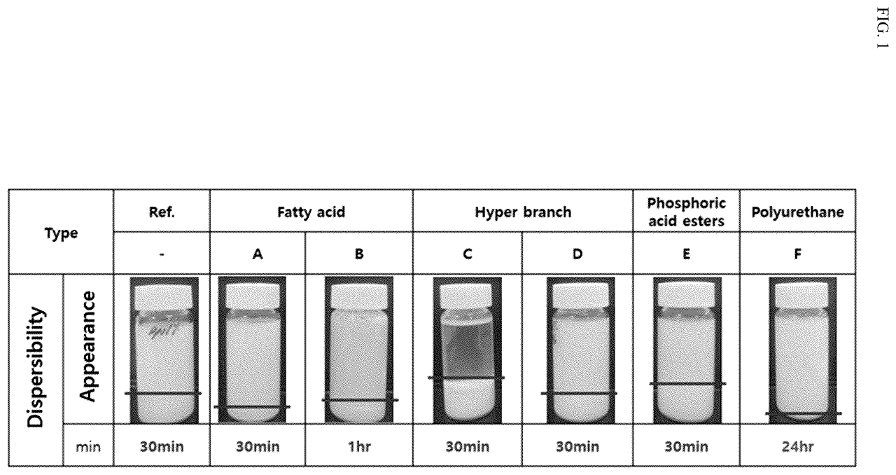

Dispersibility of boron nitride (BN) was evaluated by comparing appearances after mixing 1% by weight of different types of dispersants in an N,N′-dimethylacetamide (DMAc) solvent containing 1% by weight boron nitride (BN) and leaving each mixture at 23° C. for a certain period of time. Here, the dispersants used were fatty acids A and B, hyper branch C and D, phosphoric acid ester E, and polyurethane-based dispersant F, and the appearances to confirm the dispersibility depending on the dispersant are shown in FIG. 1.

According to FIG. 1, when the polyurethane-based dispersant was used, it was confirmed that the dispersibility of boron nitride (BN) was excellent, and it was considered that the dispersibility of boron nitride was improved due to the strong polarity of the polyurethane-based dispersant.

### Experimental Example 2. Evaluation of Physical Properties

Physical properties of cured products of Examples 2-1 to 2-3 and Comparative Examples 2-1 and 2-2 obtained by curing the polyimide varnishes prepared according to Examples 1-1 to 1-3 and Comparative Examples 1-1 to 1-2 were confirmed in the following manner, and results thereof are shown in Table 2 below.

### (1) Glass Transition Temperature (Tg)

The peak value of tangent delta (Tan δ) on the cured polyimide varnish was measured using dynamic mechanical analysis (DMA) under conditions where the temperature was raised up to 450° C. at a rate of 10° C./min.

### (2) Thermal Decomposition Temperature at 5% Weight Loss (Td 5%)

TA's thermogravimetric analyzer Q50 was used, and the cured polyimide varnish was heated up to 150° C. at a rate of 10° C./min under a nitrogen atmosphere and then maintained isothermally for 30 minutes to remove moisture. Then, the temperature was raised up to 600° C. at a rate of 10° C./min, and the temperature at which 5% weight loss occurred was measured.

### (3) Dielectric Breakdown Voltage (BDV)

The BDV value of the cured product of polyimide varnish was measured according to the ASTMD149 standard. Specifically, the cured product was pretreated in an oven at 100° C. to remove moisture, and then the cured product was fixed to PHENIX's TECHNOLOGIES 6CCE50-5 tester set to a room temperature atmosphere, and placed on the lower sample table. Then, BDV was measured by applying a voltage of 10KVAc using the upper electrode jig and increasing it at a constant rate from 0.

### (4) Thermal Conductivity

Thermal diffusivity in a thickness direction of the cured polyimide varnish was measured according to a laser flash method using thermal diffusivity measurement equipment (Model LFA 447, NETZSCH. GmbH, Selb, Germany), and thermal conductivity was calculated by multiplying the thermal diffusivity measured values by density (weight/volume) and specific heat (specific heat measured value using DSC). In addition, the thermal conductivity after 6 days was also confirmed to check changes over time.

TABLE 2

| | | | Comparative | Comparative | | | |
|---|---|---|---|---|---|---|---|
| | | | Example | Example | Example | Example | Example |
| Classification | | Unit | 2-1 | 2-2 | 2-1 | 2-2 | 2-3 |
| Additive amount | | wt % | — | 5 | 5 | 5 | 5 |
| Dispersant amount | | wt % | — | — | 0.1 | 1 | 1.5 |
| Thickness | | μm | 21 | 29 | 24 | 27 | 24 |
| Tg | | ° C. | 420 | 414 | 404 | 378 | 370 |
| Td (5%) | | μm | 501 | 564 | 560 | 533 | 520 |
| BDV | | kV/mm | 206 | 203 | 82 | 188 | 103 |
| Thermal | Initial | W/mK | 0.28 | 0.38 | 0.54 | 0.54 | 0.51 |
| conductivity | After 6 | | 0.28 | 0.30 | 0.39 | 0.54 | 0.38 |
| | days | | | | | | |

It could be confirmed from Table 2 that the thermal conductivity of Examples 2-1 to 2-3 was significantly improved to 0.51 to 0.54 W/mK compared to the thermal conductivity of Comparative Example 2-1 (0.28 W/mK) that did not contain the additive and the dispersant. In addition, the initial thermal conductivity was compared with the thermal conductivity after 6 days in order to confirm changes over time, and as a result, it could be confirmed that the dispersibility and physical properties of Example 2-2 were maintained. From these results, the appropriate combination of dispersant and additive made it possible to obtain polyimide varnish that maintains heat dissipation characteristics despite changes over time and has dispersibility to the additive (BN).

In the specification, details capable of being sufficiently recognized and inferred by those skilled in the art of the present invention are omitted, and various modifications can be made within the scope that does not change the technical spirit or essential configuration of the present invention other than the specific examples described in the present specification. Therefore, the present invention may be practiced in ways other than those specifically described and exemplified herein, which can be understood by those skilled in the art.

1. Polyimide varnish comprising:
a polyamic acid solution containing diamine monomer and dianhydride monomer as polymerized units;
an additive containing boron nitride; and
a dispersant.

2. The polyimide varnish of claim 1, wherein the additive has an amount of 0.1 to 20% by weight relative to the weight of the polyamic acid solution.

3. The polyimide varnish of claim 1, wherein the additive has a particle size (D90) of 1 to 10 μm.

4. The polyimide varnish of claim 1, wherein the boron nitride is at least one selected from the group consisting of cubic boron nitride (cBN), amorphous boron nitride (aBN), and hexagonal boron nitride (hBN).

5. The polyimide varnish of claim 1, wherein the dispersant comprises at least one selected from the group consisting of a polyvinyl-based dispersant, a polyethylene-based dispersant, a polyester-based dispersant, a polycarboxylic acid ester-based dispersant, an unsaturated polyamide-based dispersant, a polycarboxylic acid-based dispersant, a polycarboxylic acid alkyl salt dispersant, a polyacrylic-based dispersant, a polyethyleneimine-based dispersant, and a polyurethanebased dispersant.

6. The polyimide varnish of claim 1, wherein the dispersant has an amount of 0.01 to 5.0% by weight relative to the weight of the polyamic acid solution.

7. The polyimide varnish of claim 1, wherein the dianhydride monomer comprises at least one selected from the group consisting of pyromellitic dianhydride (PMDA), biphenyl tetracarboxylic dianhydride (BPDA), benzophenone tetracarboxylic dianhydride (BTDA), oxidiphthalic dianhydride (ODPA), diphenylsulfone-3,4,3′,4′-tetracarboxylic dianhydride (DSDA),
bis(3,4-dicarboxyphenyl) sulfide dianhydride,
2,2-bis(3,4-dicarboxyphenyl)-1,1,1,3,3,3-hexafluoropropane dianhydride,
2,3,3′,4′-benzophenone tetracarboxylic dianhydride,
bis(3,4-dicarboxyphenyl) methane dianhydride,
2,2-bis(3,4-dicarboxyphenyl) propane dianhydride, p-phenylenebis(trimelytic monoester acid anhydride), p-biphenylenebis(trimelytic monoester acid anhydride), m-terphenyl-3,4,3′,4′-tetracarboxylic dianhydride, pterphenyl-3,4,3′,4′-tetracarboxylic dianhydride,
1,3-bis(3,4-dicarboxyphenoxy)benzene dianhydride,
1,4-bis(3,4-dicarboxyphenoxy)benzene dianhydride,
1,4-bis(3,4-dicarboxyphenoxy) biphenyl dianhydride,
2,2-bis[(3,4-dicarboxyphenoxy)phenyl]propane dianhydride (BPADA),
2,3,6,7-naphthalene tetracarboxylic acid dianhydride,
1,4,5,8-naphthalenetetracarboxylic dianhydride, and
4,4′-(2,2-hexafluoroisopropylidene)diphthalic acid dianhydride.

8. The polyimide varnish of claim 1, wherein the diamine monomer comprises at least one selected from the group consisting of
1,4-diaminobenzene (PPD), 4,4′-diaminodiphenyl ether (ODA),
2,2-bisaminophenoxyphenylpropane (BAPP), metaphenylenediamine,
3,3′-dimethylbenzidine, 2,2′-dimethylbenzidine, 2,4-diaminotoluene,
2,6-diaminotoluene, 3,5-diaminobenzoic acid (DABA),
3,4′-diaminodiphenyl ether, 4,4′-diaminodiphenylmethane
(4,4′-methylenedianiline), 3,3′-dimethyl-4,4′-diaminobiphenyl,
2,2′-dimethyl-4,4′-diaminobiphenyl (m-tolidine),
2,2′-bis(trifluoromethyl)-4,4′-diaminobiphenyl,
3,3′-dimethyl-4,4′-diaminodiphenylmethane,
3,3′-dicarboxy-4,4′-diaminodiphenylmethane,
3,3′,5,5′-tetramethyl-4,4′-diaminodiphenylmethane,
bis(4-aminophenyl) sulfide, 4,4′-diaminobenzanilide,
3,3′-dimethoxybenzidine, 2,2′-dimethoxybenzidine,
3,3′-diaminodiphenyl ether, 3,3′-diaminodiphenyl sulfide,
3,4′-diaminodiphenyl sulfide, 4,4′-diaminodiphenyl sulfide,
3,3′-diaminodiphenyl sulfone, 3,4′-diaminodiphenyl sulfone,
4,4′-diaminodiphenylsulfone, 3,3′-diaminobenzophenone,
4,4′-diaminobenzophenone, 3,3′-diamino-4,4′-dichlorobenzophenone,
3,3′-diamino-4,4′-dimethoxybenzophenone,
3,3′-diaminodiphenylmethane, 3,4′-diaminodiphenylmethane,
2,2-bis(3-aminophenyl) propane, 2,2-bis(4-aminophenyl) propane,
2,2-bis(3-aminophenyl)-1,1,1,3,3,3-hexafluoropropane,
2,2-bis(4-aminophenyl)-1,1,1,3,3,3-hexafluoropropane,
3,3′-diaminodiphenyl sulfoxide, 3,4′-diaminodiphenyl sulfoxide,
4,4′-diaminodiphenyl sulfoxide, 1,3-bis(3-aminophenyl)benzene,
1,3-bis(4-aminophenyl)benzene, 1,4-bis(3-aminophenyl)benzene,
1,4-bis(4-aminophenyl)benzene, 1,3-bis(4-aminophenoxy)benzene (TPE-R), 1,4-bis(3-aminophenoxy)benzene (TPE-Q),
1,3-bis(3-aminophenoxy)-4-trifluoromethylbenzene,
3,3′-diamino-4-(4-phenylphenoxy)benzophenone,
3,3′-diamino-4,4′-di(4-phenylphenoxy)benzophenone,
1,3-bis(3-aminophenyl sulfide)benzene, 1,3-bis(4-aminophenyl sulfide)benzene, 1,4-bis(4-aminophenyl sulfide)benzene,
1,3-bis(3-aminophenylsulfone)benzene,
1,3-bis(4-aminophenylsulfone)benzene,
1,4-bis(4-aminophenylsulfone)benzene,
1,3-bis[2-(4-aminophenyl) isopropyl]benzene,
1,4-bis[2-(3-aminophenyl) isopropyl]benzene,
1,4-bis[2-(4-aminophenyl) isopropyl]benzene,
3,3′-bis(3-aminophenoxy) biphenyl, 3,3′-bis(4-aminophenoxy) biphenyl,
4,4′-bis(3-aminophenoxy) biphenyl, 4,4′-bis(4-aminophenoxy) biphenyl,
bis[3-(3-aminophenoxy)phenyl]ether,
bis[3-(4-aminophenoxy)phenyl]ether,
bis[4-(3-aminophenoxy)phenyl]ether,
bis[4-(4-aminophenoxy)phenyl]ether,
bis[3-(3-aminophenoxy)phenyl]ketone,
bis[3-(4-aminophenoxy)phenyl]ketone,
bis[4-(3-aminophenoxy)phenyl]ketone,
bis[4-(4-aminophenoxy)phenyl]ketone,
bis[3-(3-aminophenoxy)phenyl]sulfide,
bis[3-(4-aminophenoxy)phenyl]sulfide,
bis[4-(3-aminophenoxy)phenyl]sulfide,
bis[4-(4-aminophenoxy)phenyl]sulfide,
bis[3-(3-aminophenoxy)phenyl]sulfone,
bis[3-(4-aminophenoxy)phenyl]sulfone,
bis[4-(3-aminophenoxy)phenyl]sulfone,
bis[4-(4-aminophenoxy)phenyl]sulfone,
bis[3-(3-aminophenoxy)phenyl]methane,
bis[3-(4-aminophenoxy)phenyl]methane,
bis[4-(3-aminophenoxy)phenyl]methane,
bis[4-(4-aminophenoxy)phenyl]methane,
2,2-bis[3-(3-aminophenoxy)phenyl]propane,
2,2-bis[3-(4-aminophenoxy)phenyl]propane,
2,2-bis[4-(3-aminophenoxy)phenyl]propane,
2,2-bis[3-(3-aminophenoxy)phenyl]-1,1,1,3,3,3-hexafluoropropane,
2,2-bis[3-(4-aminophenoxy)phenyl]-1,1,1,3,3,3-hexafluoropropane,
2,2-bis[4-(3-aminophenoxy)phenyl]-1,1,1,3,3,3-hexafluoropropane, and
2,2-bis[4-(4-aminophenoxy)phenyl]-1,1,1,3,3,3-hexafluoropropane.

9. The polyimide varnish of claim 1, wherein the polyamic acid solution contains 90 to 110 mol % of the diamine monomer.

10. The polyimide varnish of claim 1, wherein the polyamic acid solution contains 90 to 110 mol % of the dianhydride monomer.

11. The polyimide varnish of claim 1, wherein the polyamic acid solution contains the dianhydride monomer and the diamine monomer in a molar ratio of 6:4 to 4:6.

12. The polyimide varnish of claim 1, wherein the polyamic acid solution further contains an organic solvent.

13. The polyimide varnish of claim 12, wherein the organic solvent comprises at least one selected from the group consisting of Nmethyl-pyrrolidone (NMP), N,N′-dimethylformamide (DMF), N,N′-diethylformamide (DEF), N,N′-dimethylacetamide (DMAc), dimethylpropanamide (DMPA), naphtha, diethylpropionamide (DEPA), N-ethylpyrrolidone (NEP), xylene, gamma-butyrolactone, gamma-valerolactone, and N,N-diethylacetamide (DEAc).

14. The polyimide varnish of claim 1, wherein the polyimide varnish has a solid content of 5 to 40% by weight.

15. The polyimide varnish of claim 1, wherein thermal conductivity after curing the polyimide varnish is 0.2 to 10.0 W/mK.

16. The polyimide varnish of claim 1, wherein a glass transition temperature (Tg) after curing the polyimide varnish is 200 to 450° C.

17. The polyimide varnish of claim 1, wherein a thermal decomposition temperature (Td) at 5% weight loss after curing the polyimide varnish is 400 to 600° C.

18. A polyimide coating material comprising a cured product of the polyimide varnish according to any one of claims 1 to 17.

19. An electric wire comprising the polyimide coating material according to claim 18.

20. An electronic device comprising the electric wire according to claim 19.
